(19) United States
(12) Patent Application Publication
(10) Pub. No.: US 2021/0349956 A1
(43) Pub. Date: Nov. 11, 2021

(54) TECHNIQUES FOR AN AGENT-ASSISTED BROWSING SYSTEM

(71) Applicant: Alto Ventures, Inc., Henderson, NV (US)

(72) Inventors: Wendell Brown, Henderson, NV (US); Nicholas Miller, West Vancouver (CA); Mark Klein, Los Altos, CA (US)

(21) Appl. No.: 16/952,068

(22) Filed: Nov. 18, 2020

Related U.S. Application Data
(63) Continuation of application No. 14/315,198, filed on Jun. 25, 2014, now abandoned.
(60) Provisional application No. 61/839,235, filed on Jun. 25, 2013.

(51) Int. Cl. G06F 16/958; G06F 16/951; G06F 40/143

(52) U.S. Cl. CPC G06F 16/958; G06F 40/143; G06F 16/951

(57) ABSTRACT

Techniques are disclosed for agent-assisted information browsing. In one example, an audio connection is established between a mobile device and an agent platform. In addition, a web service is established between the mobile device and the agent platform. The mobile device requests information through audio connection and/or web service. The agent platform searches a database for requested information and updates a webpage on the mobile device through the web service.

### CROSS-REFERENCE TO RELATED APPLICATIONS

This is a continuation application of U.S. patent application Ser. No. 14/315,198, filed Jun. 25, 2014, which claims the benefit of U.S. Provisional Application No. 61/839,235, filed Jun. 25, 2013, the contents of which are incorporated herein by reference in their entirety.

### TECHNICAL FIELD

The present invention relates generally to e-commerce, and more particularly to a method and system for agent-assisted information browsing.

### BACKGROUND

Internet websites have become media-rich and complex—a trend facilitated by the ever increasing display and processing capabilities of inexpensive personal computers. Size and resolution of monitors have increased as prices have fallen. E-commerce websites have exploited these trends by increasing amount of information, such as number of available options, textual descriptions, images, and video on their websites over time.

More recently, mobile Internet-connected devices have enjoyed rapid consumer adoption due to their portability, which is provided, in part, by a smaller display screen than desktop and laptop computers. Many traditional computer tasks may now be performed on a mobile device. Therefore, shifting Internet browsing from computers to mobile devices. However, mobile devices may only display a small fraction of the area that a traditional computer monitor displays. Because of battery life and processing speed trade-offs, mobile devices are designed to have less processing power than a typical personal computer, which may further constrain Internet browsing on mobile devices.

Improvements are needed when using a mobile device to browse through the multitude of options found on a typical e-commerce website. These improvements should reduce consumer frustration with their mobile device's small window, and to reduce lost sales for e-commerce vendors when consumers abandon the browsing session out of frustration before making a purchase.

Many types of sales, such as car rental, airline reservations, and hotel bookings are more easily performed by human-to-human interaction. However, presence of human agent in making these sales adds a significant cost to the seller.

### SUMMARY

A method for an agent-assisted browsing system that may be performed by an agent platform includes, in part, establishing an audio connection between the agent platform and a mobile device, and establishing a web service between the agent platform and the mobile device. The web service includes a first web page on the agent platform and a second web page on the mobile device. The method further includes, in part, receiving a request for information from the mobile device through the audio connection, selecting the requested information from a database, and sending the selected information to the second web page on the mobile device.

In one embodiment, the method further includes receiving an input from the mobile device in response to the received information. If the input indicates a request for purchase, the agent platform initiates a billing procedure on the second webpage in response to said request. If the input indicates a new category selected by the mobile device, the agent platform selects a second set of information corresponding to the new category and send the selected second set of information to the mobile device.

In one example, the agent platform is a computing device. The audio connection uses voice over internet protocol (VoIP). In another example, the agent platform includes a mobile phone and a computing device, said audio connection is made through cellular technology using the mobile phone. In other examples, the audio connection is connected via POTS (Plain Old Telephone System), a web-browser HTML or HTML5 voice client (e.g., one flavor of VoIP), voice functionality built into a mobile application (such as Viber, Skype, and the like), or any other method. In general, the audio connection may use any method without departing from the teachings of the present disclosure.

In one embodiment, the agent platform receives a connection request from a mobile device and establishes the audio connection based on the request. The connection request is received directly from the mobile device. In another embodiment, the connection request is received through a server.

In one embodiment, the method further includes, in part, receiving a plurality of characteristics from the mobile device and storing the plurality of characteristics in the database.

A method for an agent-assisted browsing system that may be performed by a mobile device, in accordance with another embodiment of the present invention, includes, in part, establishing an audio connection between the mobile device and an agent platform, and establishing a web service between the mobile device and the agent platform. The web service may include a first web page on the agent platform and a second web page on the mobile device. The method further includes sending a first request for information to the agent platform through the audio connection, and receiving the requested information on the second web page on the mobile device.

In one embodiment, the method further includes selecting an option in response to the received information and receiving a billing webpage on the second webpage, if the selected option is a request for purchase. The method further includes receiving a second set of information, if said option indicates a request for more information.

In one embodiment, the audio connection is through voice over internet protocol (VoIP). In another embodiment, the agent platform includes a mobile phone and a computing device. The audio connection is made through cellular technology.

In one embodiment, the method further includes sending a connection request to the agent platform, and establishing the audio connection with the agent platform. In one embodiment, the connection request is sent to a server. The server may then send the connection request to the agent platform.

A method for an agent-assisted browsing system that may be performed by a server, in accordance with one embodiment of the present invention, includes, in part, receiving a request message from a mobile device, selecting an agent platform corresponding to the received message, and sending information corresponding to the mobile device to the agent platform. The agent platform establishes audio connection and web connection with the mobile device using the information.

In one embodiment, the method further includes receiving a request from the agent platform. The request corresponds to information requested by the user through voice connection with the mobile device. The method may also include searching a database for the requested information to find a first set of data, and sending the first set of data to the agent platform. In one embodiment, the server stores information corresponding to the mobile device in the database.

A system for an agent-assisted browsing, in accordance with one embodiment of the present invention, is configured to establish an audio connection with a mobile device, and establish a web service with the mobile device. In one example, the web service includes a first web page on an agent platform and a second web page on the mobile device. The system is further configured to receive a request for information from the mobile device through the audio connection, select the requested information from a database, and send the selected information to the second web page on the mobile device.

A system for an agent-assisted browsing, in accordance with one embodiment of the present invention, is configured to establish an audio connection with an agent platform, and establish a web service with the agent platform. In one example, the web service includes a first web page on the agent platform and a second web page on the mobile device. The system may further send a first request for information to the agent platform through the audio connection and receive the requested information on the second web page on the mobile device.

A system for agent-assisted browsing, in accordance with one embodiment of the present invention, is configured to receive a request message from a mobile device, select an agent platform corresponding to the received message, and send information corresponding to the mobile device to the agent platform. The agent platform establishes audio connection and web connection with the mobile device using the information.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a simplified block diagram of an e-commerce environment.

FIG. 2 depicts a simplified block diagram of an agent assisted browsing system, according to one embodiment.

FIG. 3 depicts a simplified flow chart of a method for processing a request using the system depicted in FIG. 2, according to one embodiment.

FIG. 4 depicts a simplified flow chart of a method for agent assisted browsing using the system depicted in FIG. 2, according to one embodiment.

FIG. 5 illustrates an example flow diagram for an agent-assisted browsing system, according to one embodiment.

FIG. 6 illustrates exemplary operations for an agent-assisted browsing system that may be performed by an agent platform, according to one embodiment.

FIG. 7 illustrates exemplary operations for an agent-assisted browsing system that may be performed by a mobile device, according to one embodiment.

FIG. 8 illustrates exemplary operations for an agent-assisted browsing system that may be performed by a server, according to one embodiment.

FIG. 9 depicts a simplified block diagram of a computer system that may incorporate one embodiment.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

The word “exemplary” is used herein to mean “serving as an example, instance, or illustration.” Any embodiment or design described herein as “exemplary” is not necessarily to be construed as preferred or advantageous over other embodiments or designs.

As used herein, the term “mobile device” refers to any devices that can be moved from one place to another. A mobile device may be used to communicate with another device through cellular communications, wireless local area network (LAN), or any other method. A mobile device includes cellular phone, mobile phone, smart phone, tablet, personal digital assistant (PDA), and the like.

As used herein, the term caller, user, consumer refers to a user of a mobile device. In general, the user may concurrently use any number of devices without departing from teachings of the present disclosure.

Sales via websites generally have much lower cost than sales via agents. The balance between website abandonment and agent-assisted sales has been reached based on the use of personal computers, which commonly use large monitors. The shift to mobile browsing has created consumer frustration with e-commerce websites and possibly lost sales for e-commerce vendors.

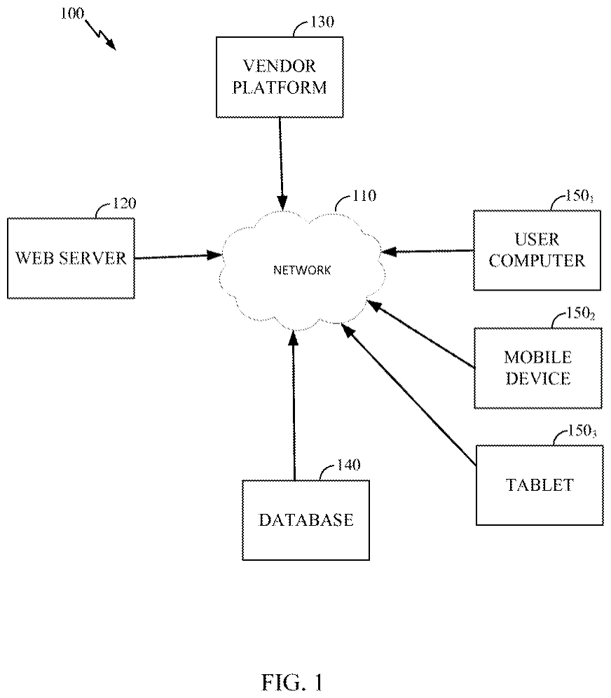

FIG. 1 depicts a simplified block diagram of an e-commerce environment 100. As illustrated, the e-commerce environment includes a Network 110, a web server 120, a vendor platform 130, a database 140. In addition, a multitude of user devices (e.g., 150₁ through 150₃) can be connected to the network. As an example, user computer 150₁, mobile device 150₂ and tablet computer 150₃ are connected to the network. In one example, network 110 is an internet network. Web server 120 may host the vendor's web site. Vendor platform 130 may include a server used by the vendor. Data corresponding to different products, vendors, devices, etc. are stored in the database. User devices visit vendor's website to view and/or purchase products.

According to one embodiment, a system and method permits an agent to guide the browsing experience of a user, concurrently with an audio communication. During a browsing session, user and agent are connected verbally over the audio connection. Concurrently, the system permits the agent to control the visual display of options on the user's mobile device. By combining the personal guidance of an agent with the visual display of options enabled by the mobile device, the mobile browsing experience may thus be improved to reduce vendor costs and increase consumer satisfaction.

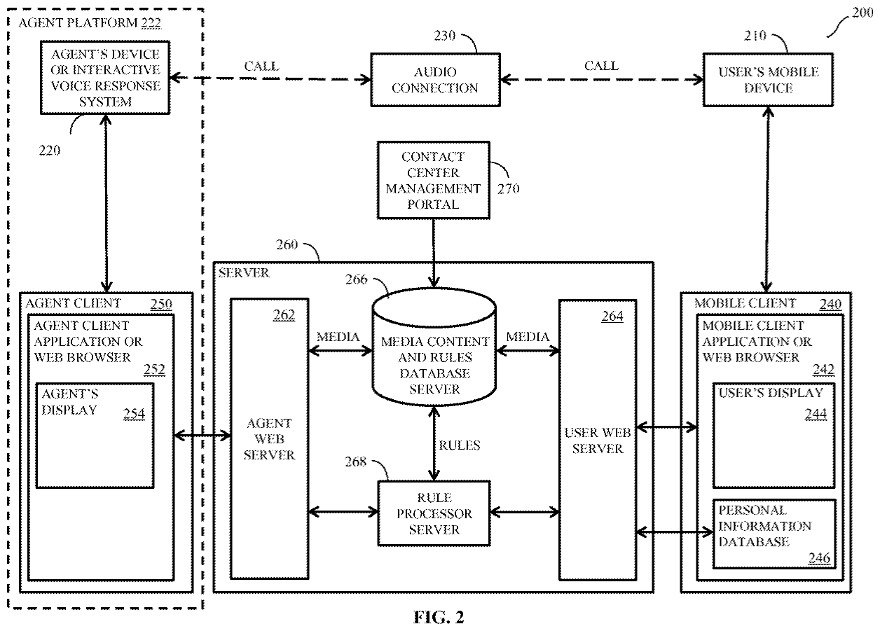

FIG. 2 depicts a simplified block diagram of an agent-assisted browsing system 200, in accordance with one embodiment. Agent assisted browsing system 200 may include a user's mobile device 210, an agent platform 222 a mobile client 240, a server 260, and a contact center management portal 270. The agent platform 222 may include an agent's phone or interactive voice response (IVR) system 220, and an agent client 250. The user's mobile device 210 is coupled to the agent's phone or interactive voice response (IVR) system 220 via an audio channel 230. The audio channel 230 may utilize a cellular network, voice over internet protocol (VoIP), or any other method conveying audio information. The agent may be a human agent or a server using an IVR system, which may recognize speech and/or audio tone signals, such as those generated via telephone keypad. In one embodiment, agent-assisted browsing system 200 includes both a human agent and an IVR system running on a server to receive audio-based calls from user's mobile device 210.

Mobile client 240 may include a mobile client application, hereinafter also referred to as mobile client app, or web browser 242, a user's display 244, and a personal information database 246. In one embodiment, mobile client 240 may reside in user's mobile device 210. For example, the user's mobile device is a smart phone, which may include a processor and user's display 244, a wireless radio transceiver that may operate on WiFi®, Bluetooth®, and/or cellular radio transmission standards that may access a cellular audio or voice network, and the Internet.

Alternatively, in another embodiment, mobile client 240 may reside in a different mobile device than user's mobile device 210, in which case user's mobile device 210 may be either a smart phone or any other type of phone. Examples of such different mobile devices may include any portable computing device, which includes a processor and user's display 244, such as a laptop, mini, tablet, or pad, which may or may not include a wireless radio transceiver that may link the mobile device through a base station or directly providing Internet access.

In one embodiment, personal information database 246 may include identification information such as the user's name, address, phone number, email address, account number, and the like. The user's personal information database 246 may further include information stored from past transactions, loyalty numbers, and the like, and/or past or present geographic location associated with the user or the user's transactions. In one embodiment, a portion of the information stored in personal information database 246 may be accessible to agent assisted browsing system 200 to, for example, facilitate secure transactions.

In one embodiment, under the user's control or approval, pertinent elements from the user's personal information database 246 are transferred to the agent's display view, or potentially directly into a database in an order fulfillment system within or outside server 260 without being displayed to the agent. In one embodiment, the personal information data may be displayed to the agent, who would then copy it into the ordering system. Alternatively, in one embodiment, the personal information data could be sent directly to the ordering system, while the agent would be informed of the personal information data transfer but might not see the information, such as a credit card number, for example.

In one embodiment, agent's platform 222 may include one or more devices. In one example, a single device is capable of providing audio connection and web connection with the user. In this example, agent's platform includes a computer system that is capable of providing a voice connection (e.g., VoIP). In another example, agent's platform includes two devices that are coupled to each other. For example, agent's platform includes a phone for providing audio connection and a desktop computer capable of browsing internet. In general, any number of devices may be used by either the user or the agent without departing from teachings of the present disclosure.

The agent platform 222 includes agent's phone or IVR system 220, and agent client 250. Agent client 250 may include an agent client application, hereinafter also referred to as agent client app, or web browser 252 and an agent display 254. In one embodiment, agent display 254 may be a standard desktop computer monitor and may include a larger display area than user's display 244. In one embodiment, agent client 250 may reside in a desktop or any other type of computer system.

In one embodiment, server 260 includes agent web server 262, user web server 264, media content and rules database server 266, and rule processor server 268. Media content and rules database server 266 stores a multitude of media content that may be transmitted to agent web server 262 and/or user web server 264. Media content and rules database server 266 further stores a multitude of rules that may be transmitted to rule processor server 268, which is coupled to agent web server 262 and/or user web server 264. Media content and rules database server 266 may be further coupled to contact center management portal 270. Agent web server 262 is coupled to agent client application or web browser 252 via an Internet connection. User web server 264 is coupled to user client application or web browser 242 via another Internet connection.

It is understood that the agent web server 262, user web server 264, media content and rules database server 266, and rule processor server 268 may each implement one or more modules of software each including a multitude of lines of computer-executable code, that may be executed by one or more processors of a computer or server system. The computer-executable code may be stored on a non-transitory computer readable medium. It is understood that the associated software modules executed on agent web server 262, user web server 264, media content and rules database server 266, and rule processor server 268 may be combined in any combination, for example executed on one or more physical servers. It is understood further that any of the agent web server 262, user web server 264, media content and rules database server 266, and rule processor server 268 or their associated software modules may be further divided or distributed among a multitude of other servers, a set of load-balanced servers, or a cloud computing virtual server. It is understood that agent assisted browsing system 200 may implement one or more different methods for agent-assisted mobile browsing.

Agent assisted browsing system 200 as described above is one embodiment of a more general technique of multiple person interaction over the Internet with a set of media elements. In a traditional web session, a single user interacts with the media presented by a website by utilizing presented navigational elements such as buttons and links. When the user clicks on a link, for example, the web server may change the media content or elements displayed to the user. This is a traditional client/server architecture or Model View Controller (MVC) design pattern.

In contrast, agent assisted browsing system 200 has at least two controllers. In one embodiment, a user (e.g., a first controller) may utilize a mobile device to interact with the agent assisted browsing system. The agent platform may also be operated by a human or an IVR system (e.g., second controller). These two controllers may, by interacting with agent assisted browsing system 200, change the associated views presented by the system to each of them. In other words, the view presented on agent's display 254 may be different than but associated with the view presented on user's display 244. The two controllers may be connected by an audio link, shown as dashed arrows in FIG. 2, through which the two controllers convey information that assists them in their respective non-verbal interaction with agent assisted browsing system 200. The multitude of rules in agent assisted browsing system 200 provide further assistance, enabling the agent using the larger agent's display to facilitate, guide, recommend or winnow media information that is in-turn transmitted to the smaller user's display 244.

In one embodiment, the views on agent's display 254 and/or user's display 244 may be driven by a web browser application running respectively on agent client 250 and mobile client 240. In another embodiment the views on agent's display 254 and/or user's display 244 may be driven respectively by an agent and/or mobile client application or any combination web browser and application. For example, agent's display 254 may be driven by a web browser, while user's display 244 may be driven by a mobile client application. In one embodiment, user's display 244 may be driven initially by a web browser and later by a mobile client application.

In one embodiment, Contact Center Management Portal 270 facilitates the configuration of the system including the uploading of media content and the rules to the media content and rules database server 266. The server 260 is pre-loaded with media content and rules for the winnowing of that content with the goal of identifying and satisfying the aligned needs of the user and the entity employing the agent, typically a vendor. The rules control the agent's and user's interaction with that media content. As used herein the term media content refers to any information conveyed to the user, including text, images, audio files, video files, etc.

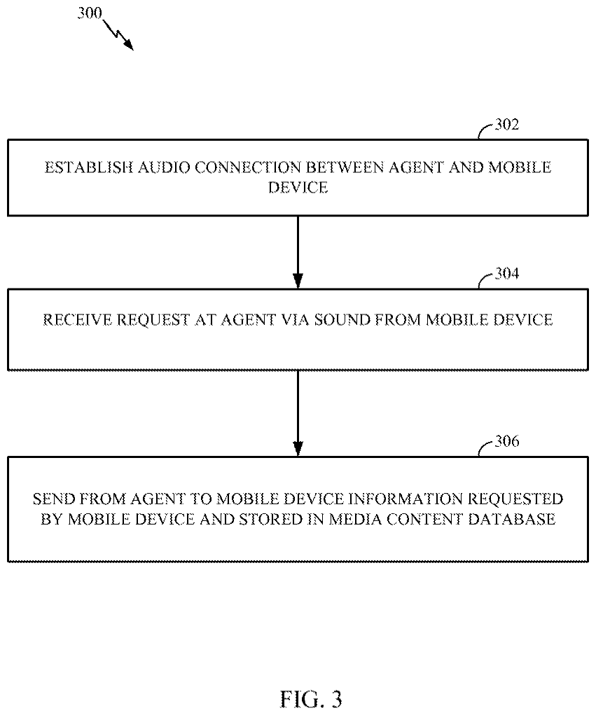

FIG. 3 depicts a simplified flow chart of a method for processing a request 300 using the agent assisted browsing system depicted in FIG. 2, in accordance with one embodiment of the present invention. Referring simultaneously to FIG. 2 and FIG. 3, method for processing a request 300 starts with establishing, at 320, an audio connection between an agent or IVR system 220 and a user device, such as a mobile device 210. The audio connection may be via cellular phone or voice network or via Internet network using VoIP. In one embodiment, the audio connection may be initiated by user's mobile device 210 calling agent's device, i.e., the user calls the agent. In another embodiment, the user may have previously left instructions or an “open ticket” for agent or IVR system 220 to initiate the audio connection later by agent's device 220 calling user's mobile device 210, i.e., the agent calls the user.

In one embodiment, the user and agent are human beings, which use their respective devices 210, 220 to simply communicate by speech. In another embodiment, the agent's phone 220 may communicate by using pre-recorded voice messages that ask a series of questions to lead the human user through a decision tree. In one embodiment, the user may use user's mobile device 210 to reply by voice. In one embodiment, the user may use user's mobile device 210 to reply by pressing one of a multitude of numeric keypads or other buttons or icons on user's mobile device 210 that may generate audio tones. In one embodiment, the agent's IVR system may recognize voice or speech. In one embodiment, the agent's IVR system may recognize the audio tones. In another embodiment, the user may respond to instructions from the agent by pressing a link on the website visible on his/her mobile device display.

At 330, the agent or IVR system 220 receives a request from the mobile device 210 via a sound on the audio connection, voice network or VoIP 230. For example, the user may want to purchase red roses and communicates that request to the agent.

At 340, the agent client send information requested by user's mobile device 210 in the preceding step to the user device or mobile client 240. The agent client may include one or more processors associated with a computer executing the code resident in server 260. The agent uses the request and other information available to the system to select the most appropriate response to the requested information. The information provided to the agent comes to the agent from verbal interaction with the user or by a combination of verbal communications and actions performed on the mobile device. In addition, the information may come from information stored in the user's personal information database 246, and may be combined with information stored in the server's database and/or queries to other data sources.

The agent evaluates the multitude of possible media content choices associated with a complex website to selectively provide the information requested by the user and to filter out media content unrelated to the user's request. Thus, mobile client 240 receives and displays a reduced number of information options than would be displayed by viewing a complex webpage designed for viewing on a larger display (e.g., desktop monitor).

The requested information sent to the user's mobile client 240 is responsive to the agent and agent client 250. The requested information may be a subset of the media content stored in media content and rules database server 266, such as pictures, text, video, or selectable options, and the like. In other words the agent who is controlling agent client 250, presents or pushes the requested information to mobile client 240 based on the information provided to the agent. In one embodiment, the agent may view a complex webpage during the selection process. In another embodiment, the agent may view the media content stored on the complex webpage in another format such as a categorized listing or table in an agent client application.

For example, a user may be interested in buying red roses for his anniversary. The user may communicate his request to the agent at 330. In response, the agent may review a multitude of available flower categories and just select media content associated exclusively with immediately available red roses, which are sent through server 260 to mobile client 240. The user views the received information (e.g., several categories of red roses that are available for immediate purchase but no other categories of flowers and not red roses that are out of stock). The agent made the selection based on the user's need for quick delivery established when the agent received the user's request.

In another embodiment, sending 340 is executed through server 260 via a data channel such as a web browser or other application connected to the Internet, while the agent or IVR system 220 and user's mobile device 210 are concurrently connected via an audio or voice channel. It is understood that the voice channel may at times be transmitted as data over the same network as the web browser data, for example when VoIP is used by user's mobile device 210. However, the user is able to view on mobile client 240 the data selected and sent by the agent, while communicating by audio with the agent or IVR system 220.

In one embodiment, the user may take an action that is received on the mobile client 240 based on the previously received requested information. The action taken by the user may, for example, include a new selection or a purchase decision. A result of the action taken by the user and received by mobile client 240 may be returned via server 260 to agent client 250 where the action is received as a new request to be used by the agent for further iterative selection of content to be pushed to the user or for the completion of a sale or other transaction. Thus, after receiving an action at mobile client 240 responsive to the user, the steps of receiving a request 330 and sending 340 from agent client 250 to mobile client 240 may be repeated until the completion of a sale or other transaction.

For example, agent client 250 sends to mobile client 240 some pictures and/or text descriptions of four options including two bouquets with mixed flower types each including at least one red rose and two boxes of different amounts of long stemmed red roses—a gift box of one rose and a box of eight roses. The user may verbally communicate to the agent a new request to see more boxed red rose options. The agent deselects the two the mixed flower media descriptions and sends instead two new options including descriptions for boxes of one and two dozen long stemmed red roses via agent client 250. Mobile client 240 now displays four options, e.g., touch sensitive icons, for boxes of one, eight, one dozen and two dozen red roses.

In one embodiment, an agent may communicate with any number of users. For example, an agent may help two users concurrently. In this case, while one user contemplates the new displayed options, the agent may put the user on hold and help another user. When the user makes a selection (e.g., selects the box of one dozen roses for purchase) on mobile client 240, the audio call can be terminated and the user can continue the purchase procedure with server 260.

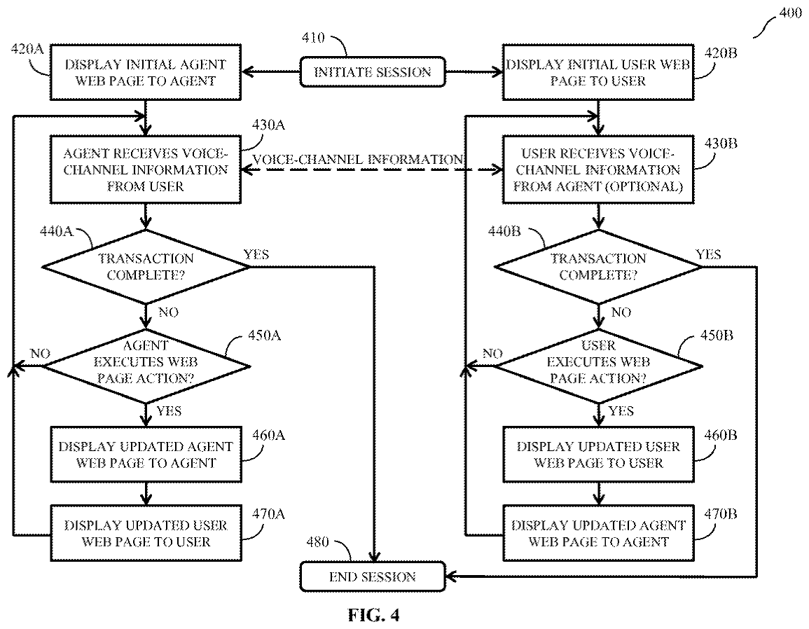

FIG. 4 depicts a simplified flow chart of a method for agent assisted browsing 400 using the system depicted in FIG. 2, in accordance with one embodiment of the present invention. Referring simultaneously to FIG. 2 and FIG. 4, method for agent assisted browsing 400 starts with initiating 410 a session, which includes establishing 320 an audio connection, e.g., over a voice-channel, between an agent or IVR system 220 and a user device, such as user's mobile device 210, previously described in reference to FIG. 2. FIG. 4 depicts symmetric flow chart steps for agent client 250 on the left side of the figure and for the mobile client on the right side of the figure with an “A” and “B” respectively appended to the element identifier numbers.

After initiating 410 the session, an initial web page is displayed 420A at agent client 250 and an initial web page is displayed 420B at user client 240. As explained above, the web page displayed to the agent may be associated with but different than the web page displayed to the client. The agent receives 430A voice-channel information from the user, which is similar to receiving 330 at agent or IVR system 220 a request from the user's mobile device 210, previously described in reference to FIG. 3.

FIG. 2 and FIG. 4 further depict one embodiment including the user optionally receiving 430B voice-channel information from the agent. In other words, the agent and user communicate by talking over the voice-channel, while viewing information on their respective web pages.

If the transaction is complete, the session is ended 480. If the transaction is not complete yet, the agent may execute 450A a web page action on agent client 250 and/or the user may execute 450B a web page action on user client 240. For example, the agent may select the information requested by the user and/or the user may select one of a multitude of selections to continue the user's selection process to find a desired good or service. If the agent does not execute a web page action the agent may continue receiving 430A voice-channel information from the user. If the user does not execute a web page action the user may continue receiving 430B voice-channel information from the agent or wait for the agent to execute a web page action.

If the agent executes a web page action, server 260 displays 460A, an updated agent web page on agent client 250 and displays 470A an updated user web page on mobile client 240. In one embodiment, the updated user webpage may display the information requested by the user. The agent may then repeat receiving 430A voice-channel information from the user. If the user executes a web page action, server 260 displays 460B, an updated user web page on mobile client 240 and sends that information to agent client 250 by displaying 470B an updated agent web page on agent client 250. The user may then repeat receiving 430B voice-channel information from the agent or wait for the agent to execute a web page action. The user and agent may thus conduct two dialogues concurrently, one by voice channel and the other via web browser through server 260. The communication via web browser uses media content stored in media content and rules database server 266 and is mediated by rule processor server 268.

In one embodiment, rules may be implemented in computer programming code, such as a scripting language, such as Ruby, Python, and the like and/or be described by a data structure that can be interpreted by a computer program. Actions taken by the agent and the user on their respective web views are non-traditional in that they don't simply fetch their own next view from a URL independently from each other. Instead, when a button or URL link is selected by either agent or client, it influences through the rules (or business logic) what is displayed on their own view and on the other party's view. For this reason, Agent Web Server 262 and User Web Server 264 may not operate in isolation. Instead, Agent Web Server 262 and User Web Server 264 may be tied together by Rule Processor Server 268, which calculates, coordinates, and arbitrates information coming in from both parties to produce the next view for each party.

The following example continues with the flower purchase scenario to provide examples of rules used according to one embodiment. Referring again to FIG. 2, a call may be received by the agent with “called number” information telling the agent this will be a flower purchase call. The agent clicks on a “Flowers” button on agent client 250. Rules may include “If Agent clicks on Flowers button, Send HTML web page to Agent, Send HTML web page to User.” An example of this rule data set is “AgentClickFlowers,” URL-Agent, URL-User.” “AgentClickFlowers” may be triggered by a URL on the Agent Web Page that points to a script on Rule Processor Server 268. The Rule Processor Server has the ability to push information to Agent Web Server 262 and User Web Server 264. The system displays high-level flower options on the agent's web view and displays a welcome screen on the user's web view.

Then a voice interaction may include the agent greeting the user with, “Hello, how may I help you?” The user may reply, “I'm interested in an anniversary bouquet.” The agent then clicks on an “Anniversary” button on agent client 250. Rules may now include “Agent Web Server can handle this operation without contacting the rule processor server. It is a simple HTTP GET request using the URL of the link on the Flowers page.” The system may then display three categories of anniversary bouquets on the agent's web view: “Red Roses, Other Roses, and Mixed Flowers”.

The agent may ask the user, “Would you like Roses?” The user may respond, “Yes.” The agent may then ask, “Do you have a color preference?” The user may respond, “Red.” The agent then clicks on “Red Roses” on agent client 250. Rules may now include “If Agent clicks on Red Roses button, Send HTML web page to Agent, Send HTML web page to User.” The system may display eight arrangements on the agents web view. Four have checkboxes checked indicating they have been sent to the user in past transactions. The system displays those four previously selected arrangements on the users web view. The agent may say, “I've sent you four to look at. Would you like one of them or would you like some more choices?” The user responds by saying, “I want the top right one. Can I click it?” The agent responds with, “Yes.”

The user clicks the top right image which acts as a web button. Rules may now include; “If User clicks on Option 2 image, Add to shopping cart, Send shopping cart web page to Agent, Send item selected web page to User.” The system displays the selected arrangements on the user's web view. The system displays the selected arrangements on the agent's web view along with further scripting information to complete the transaction with the user.

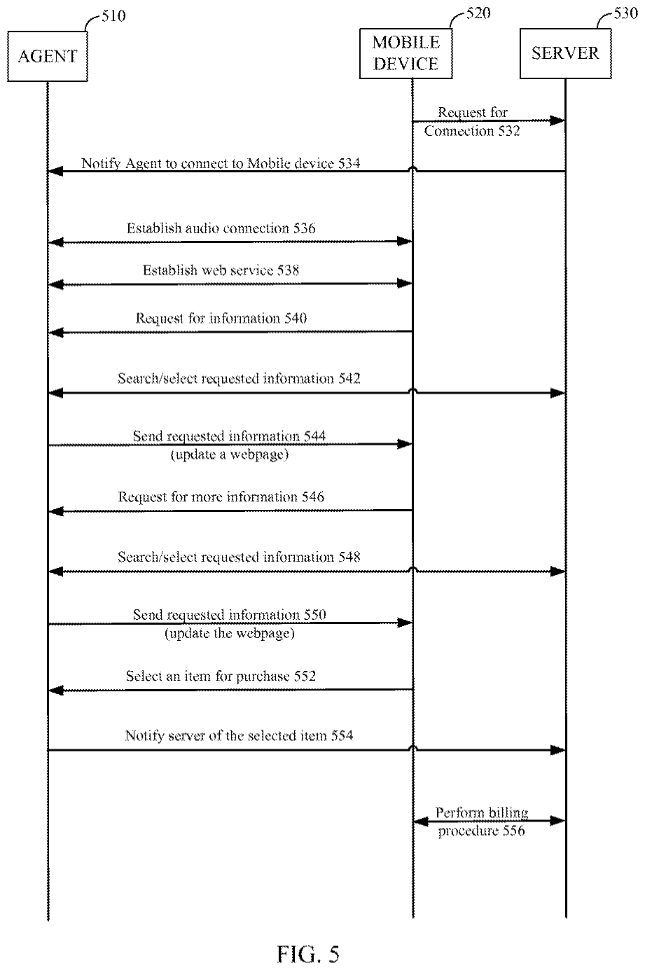

FIG. 5 illustrates an example flow diagram for an agent-assisted browsing system, according to one embodiment. In this example, a mobile device 520, an agent 510 and a server 530 communicate with each other. For example, the mobile device sends a request for connection (532) to the server. The server selects one of the agents from possibly multiple agents and notifies 534 the agent to connect with the mobile device. At 536, the agent and the mobile device establish an audio connection. At 538, the agent and the mobile device establish a web service.

At 540, the mobile device requests for specific information (e.g., red roses). At 542, the agent searches a database and selects relevant information to send to the mobile device. For example, a search by the agent may result in ten options, the agent selects a few options (e.g., 3) that are more relevant to mobile device's request and sends the requested information to the mobile device (544). In one example, the agent updates a web page associated with the mobile device with the requested information. At 546, the mobile device optionally requests for another set of information. At 548, the agent searches for the requested information and updates the webpage with the new information (at 550). The mobile device may request new information until the user is ready to purchase an item and selects the item for purchase (552). At this time, the agent can notify the server of the selected item 554. The mobile device and the server then initiate a billing procedure 556 to finish purchase. Alternatively, the agent may perform the billing procedure with the mobile device.

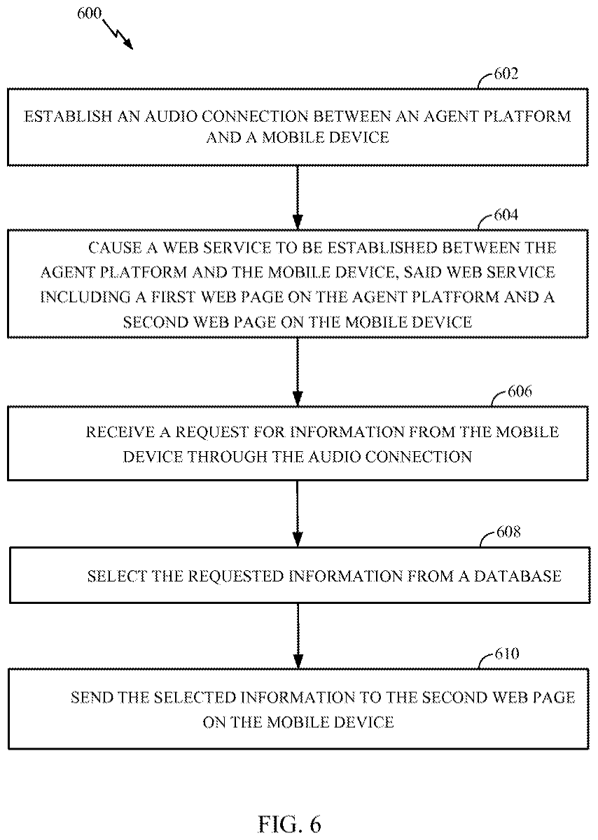

FIG. 6 illustrates exemplary operations for an agent-assisted browsing system that may be performed by an agent platform, according to one embodiment. At 602, the agent platform establishes an audio connection with a mobile device. At 604, the agent platform causes a web service to be established between the agent platform and the mobile device. The web service includes a first web page on the agent platform and a second web page on the mobile device. At 606, the agent platform receives a request for information from the mobile device through the audio connection. At 608, the agent platform selects the requested information from a database. At 610, the agent platform sends the selected information to the second web page on the mobile device.

In addition, in one embodiment, the agent platform may receive an input from the mobile device in response to the received information. If the input indicates a request for purchase, the agent platform initiates a billing procedure on the second webpage. In another embodiment, the agent platform notifies the server to initiate the billing procedure. If the input indicates a new category selected by the mobile device, the agent platform selects a second set of information corresponding to the new category and sends the selected second set of information to the mobile device.

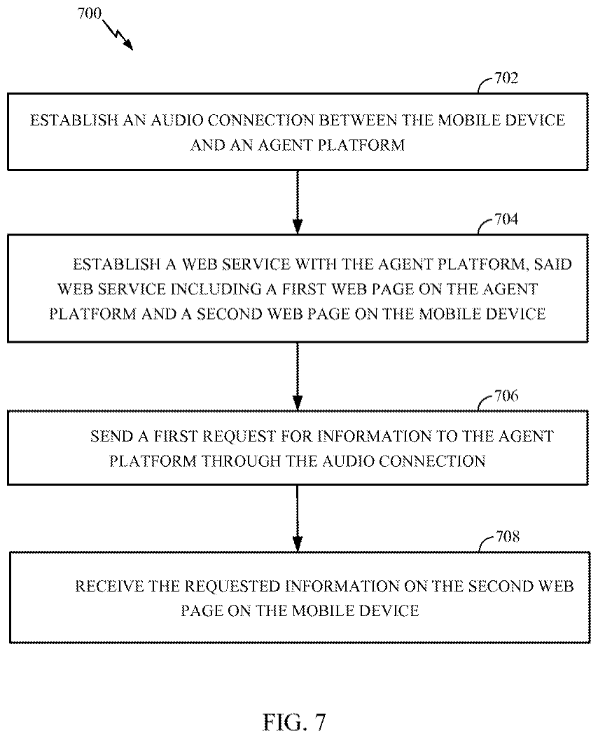

FIG. 7 illustrates exemplary operations for an agent-assisted browsing system that may be performed by a mobile device, according to one embodiment. At 702, the mobile device establishes an audio connection with an agent platform. At 704, the mobile device establishes a web service with the agent platform. The web service includes a first web page on the agent platform and a second web page on the mobile device. At 706, the mobile device sends a first request for information to the agent platform through the audio connection. At 708, the mobile device receives the requested information on the second web page on the mobile device.

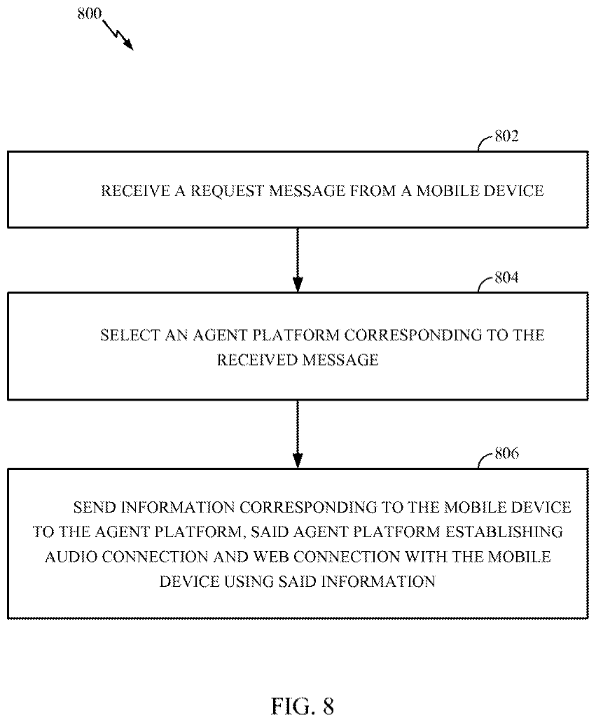

FIG. 8 illustrates exemplary operations for an agent-assisted browsing system that may be performed by a server, according to one embodiment. At 802, the server receives a request message from a mobile device. At 804, the server selects an agent platform corresponding to the received message. At 806, the server sends information corresponding to the mobile device to the agent platform. The agent platform establishes audio connection and web connection with the mobile device using said information.

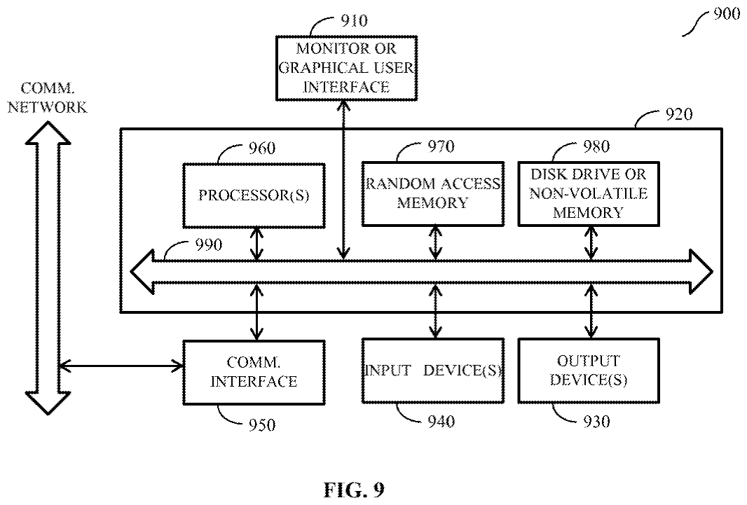

FIG. 9 depicts a simplified block diagram of a computer system that may incorporate embodiments of the present invention. FIG. 9 is merely illustrative of an embodiment incorporating the present invention and does not limit the scope of the invention as recited in the claims. One of ordinary skill in the art would recognize other variations, modifications, and alternatives.

In one embodiment, computer system 900 typically includes a monitor or 910, a computer 920, user output devices 930, user input devices 940, communications interface 950, and the like. Computer system 900 may also be a smart phone, tablet-computing device, and the like, such that the boundary of computer 920 may enclose monitor or graphical user interface 910, user output devices 930, user input devices 940, and/or communications interface 950 (not shown).

As depicted in FIG. 9, computer 920 may include a processor(s) 960 that communicates with a number of peripheral devices via a bus subsystem 990. These peripheral devices may include user output devices 930, user input devices 940, communications interface 950, and a storage subsystem, such as random access memory (RAM) 970 and disk drive or non-volatile memory 980.

User input devices 930 include all possible types of devices and mechanisms for inputting information to computer system 920. These may include a keyboard, a keypad, a touch screen incorporated into the display, audio input devices such as voice recognition systems, microphones, and other types of input devices. In various embodiments, user input devices 930 are typically embodied as a computer mouse, a trackball, a track pad, a joystick, wireless remote, drawing tablet, voice command system, eye tracking system, and the like. User input devices 930 typically allow a user to select objects, icons, text and the like that appear on the monitor or graphical user interface 910 via a command such as a click of a button, touch of the display screen, or the like.

User output devices 940 include all possible types of devices and mechanisms for outputting information from computer 920. These may include a display (e.g., monitor or graphical user interface 910), non-visual displays such as audio output devices, etc.

Communications interface 950 provides an interface to other communication networks and devices. Communications interface 950 may serve as an interface for receiving data from and transmitting data to other systems. Embodiments of communications interface 950 typically include an Ethernet card, a modem (telephone, satellite, cable, ISDN), (asynchronous) digital subscriber line (DSL) unit, FireWire interface, USB interface, and the like. For example, communications interface 950 may be coupled to a computer network, to a FireWire bus, or the like. In other embodiments, communications interfaces 950 may be physically integrated on the motherboard of computer 920, and may be a software program, such as soft DSL, or the like. Embodiments of communications interface 950 may also include a wireless radio transceiver using radio transmission protocols such as Bluetooth®, WiFi®, cellular, and the like.

In various embodiments, computer system 900 may also include software that enables communications over a network such as the HTTP, TCP/IP, RTP/RTSP protocols, and the like. In alternative embodiments of the present invention, other communications software and transfer protocols may also be used, for example IPX, UDP, or the like.

In some embodiment, computer 920 includes one or more Xeon® microprocessors from Intel as processor(s) 960. Further, one embodiment, computer 920 includes a UNIX-based operating system. In another embodiment the processor may be included in an applications processor or part of a system on a chip.

RAM 970 and disk drive or non-volatile memory 980 are examples of tangible non-transitory computer-readable media configured to store computer-executable data or code such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 970 and disk drive or non-volatile memory 980 may be configured to store the basic programming and data constructs that provide the functionality of the present invention.

Software code modules and instructions that provide the functionality of the present invention may be stored in RAM 970 and disk drive or non-volatile memory 980. These software modules may be executed by processor(s) 960. RAM 970 and disk drive or non-volatile memory 980 may also provide a repository for storing data used in accordance with the present invention.

RAM 970 and disk drive or non-volatile memory 980 may include a number of memories including a main random access memory (RAM) for storage of instructions and data during program execution and a read only memory (ROM) in which fixed instructions are stored. RAM 970 and disk drive or non-volatile memory 980 may include a file storage subsystem providing persistent (non-volatile) storage for program and data files. RAM 970 and disk drive or non-volatile memory 980 may also include removable storage systems, such as removable flash memory.

Bus subsystem 990 provides a mechanism for letting the various components and subsystems of computer 920 communicate with each other as intended. Although bus subsystem 990 is shown schematically as a single bus, alternative embodiments of the bus subsystem may utilize multiple busses.

FIG. 9 is representative of a computer system capable of embodying the present invention. It will be readily apparent to one of ordinary skill in the art that many other hardware and software configurations are suitable for use with the present invention. For example, the computer may be a desktop, laptop, portable, rack-mounted, smart phone or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc; embedded processors such as ARM® licensed from ARM® Holdings plc., and the like. Further, other types of operating systems are contemplated, such as Windows®, WindowsXP®, WindowsNT®, WindowsRT® or the like from Microsoft Corporation, Solaris from Sun Microsystems, LINUX, UNIX, or mobile operating systems such as Android® from Google Inc., iOS® from Apple Inc., Symbion® from Nokia Corp., and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The above embodiments of the present invention are illustrative and not limiting. Various alternatives and equivalents are possible. Although, the invention has been described with reference to certain servers and associated software modules by way of an example, it is understood that the invention is not limited by the type or number of servers used. Although, the invention has been described with reference to entering user selections via icons displayed on a touch sensitive screen by way of an example, it is understood that the invention is not limited by the type of data entry. For example, user data entry may be provided by pressing buttons on a computer device, via a graphical user interface/mouse selection, or by voice command, and the like.

Although, the invention has been described with reference to certain radio communications interface by way of an example, it is understood that the invention is not limited by the type of radio communications interface. Although, the invention has been described with reference to certain operating systems by way of an example, it is understood that the invention is not limited by the type of operating systems. Although, the invention has been described with reference to certain flower purchase transactions by way of an example, it is understood that the invention is not limited by the type of transaction. Other additions, subtractions, or modifications are obvious in view of the present disclosure and are intended to fall within the scope of the appended claims.

What is claimed is:

1. A method for an agent-assisted browsing system being performed by an agent platform, comprising:
establishing an audio connection between the agent platform and a mobile device;
causing a web service to be established between the agent platform and the mobile device, said web service including a first web page on the agent platform and a second web page on the mobile device;
receiving a request for information from the mobile device through the audio connection;
selecting the requested information from a database; and
sending the selected information to the second web page on the mobile device.

2. The method of claim 1, further comprising:
receiving an input from the mobile device in response to the received information;
if the input indicates a request for purchase, initiating a billing procedure on the second webpage in response to said request; and
if the input indicates a new category selected by the mobile device, selecting a second set of information corresponding to the new category and send the selected second set of information to the mobile device.

3. The method of claim 1, wherein said agent platform comprises a computing device, said audio connection uses voice over internet protocol (VoIP).

4. The method of claim 1, wherein said agent platform comprises a mobile phone and a computing device, said audio connection is made through cellular technology using the mobile phone.

5. The method of claim 1, further comprising:
receiving a connection request from a mobile device; and
establishing the audio connection based on the request.

6. The method of claim 5, wherein the connection request is received through a server.

7. The method of claim 1, further comprising:
receiving a plurality of characteristics from the mobile device; and
storing the plurality of characteristics in the database.

8. A method for an agent-assisted browsing system being performed by a mobile device, comprising:
establishing an audio connection between the mobile device and an agent platform;
establishing a web service between the mobile device and the agent platform, said web service including a first web page on the agent platform and a second web page on the mobile device;
sending a first request for information to the agent platform from the mobile device and through the audio connection; and
receiving the requested information on the second web page on the mobile device.

9. The method of claim 8, further comprising:
selecting an option in response to the received information;
if said option is a request for purchase, receiving a billing webpage on the second webpage; and
if said option indicates a request for more information, receiving a second set of information.

10. The method of claim 8, wherein the audio connection is through voice over internet protocol (VoIP).

11. The method of claim 8, wherein said agent platform comprises a mobile phone and a computing device, said audio connection is made through cellular technology.

12. The method of claim 8, further comprising:
sending a connection request to the agent platform; and
establishing the audio connection with the agent platform.

13. The method of claim 12, wherein the connection request is sent to a server.

14. A method for agent-assisted browsing system being performed by a server, comprising:
receiving a request message from a mobile device;
selecting an agent platform corresponding to the received message; and
sending information corresponding to the mobile device to the agent platform, said agent platform establishing audio connection and web connection with the mobile device using said information.

15. The method of claim 14, further comprising:
receiving a request from the agent platform, said request corresponding to information requested by the user through voice connection with the mobile device;
searching a database for the requested information to find a first set of data; and
sending the first set of data to the agent platform.

16. The method of claim 14, further comprising:
storing information corresponding to the mobile device in the database.

17. A system for an agent-assisted browsing, configured to:
establish an audio connection with a mobile device;
cause a web service to be established with the mobile device, said web service including a first web page on an agent platform and a second web page on the mobile device;
receive a request for information from the mobile device through the audio connection;
select the requested information from a database; and
send the selected information to the second web page on the mobile device.

18. The system of claim 17, further configured to:
receive an input from the mobile device in response to the received information;
if the input indicates a request for purchase, initiate a billing procedure on the second webpage in response to said request; and
if the input indicates a new category selected by the mobile device, select a second set of information corresponding to the new category and send the selected second set of information to the mobile device.

19. The system of claim 17, wherein said agent platform is a computing device, said audio connection uses voice over internet protocol (VoIP).

20. The system of claim 17, wherein said agent platform includes a mobile phone and a computing device, said audio connection is made through cellular technology using the mobile phone.

21. The system of claim 17, further configured to:
receive a connection request from a mobile device; and
establish the audio connection based on the request.

22. The system of claim 21, wherein the connection request is received through a server.

23. The system of claim 17, further configured to:
receive a plurality of characteristics from the mobile device; and
storing the plurality of characteristics in the database.

24. A system for an agent-assisted browsing, configured to:
establish an audio connection with an agent platform;
causing a web service to be established with the agent platform, said web service including a first web page on the agent platform and a second web page on a mobile device;
send a first request for information to the agent platform through the audio connection; and
receive the requested information on the second web page on the mobile device.

25. The system of claim 24, further configured to:
select an option in response to the received information;
if said option is a request for purchase, receive a billing webpage on the second webpage; and
if said option indicates a request for more information, receive a second set of information.

26. The system of claim 24, wherein the audio connection is through voice over internet protocol (VoIP).

27. The system of claim 24, wherein said agent platform includes a mobile phone and a computing device, said audio connection is made through cellular technology.

28. The system of claim 24, further configured to:
send a connection request to the agent platform; and
establish the audio connection with the agent platform.

29. The system of claim 28, wherein the connection request is sent to a server.

30. A system for agent-assisted browsing, configured to:
receive a request message from a mobile device;
select an agent platform corresponding to the received message; and
send information corresponding to the mobile device to the agent platform, said agent platform establishing audio connection and web connection with the mobile device using said information.

31. The system of claim 30, further configured to:
receive a request from the agent platform, said request corresponding to information requested by the user through voice connection with the mobile device;
search a database for the requested information to find a first set of data; and
send the first set of data to the agent platform.

32. The system of claim 30, further configured to:
store information corresponding to the mobile device in the database.
